(19) United States
(12) Patent Application Publication
(10) Pub. No.: US 2022/0053018 A1
(43) Pub. Date: Feb. 17, 2022

(54) SYSTEM AND METHOD FOR DETECTION AND MITIGATION OF A DOS/DDOS ATTACK

(71) Applicant: FLIPKART INTERNET PRIVATE LIMITED, Karnataka (IN)

(72) Inventors: Krishna KUMAR, Bangalore (IN); Vasudeva Sathish KAMATH B, Karnataka (IN)

(21) Appl. No.: 17/400,083

(22) Filed: Aug. 11, 2021

(30) Foreign Application Priority Data
Aug. 11, 2020 (IN) 202041034456

(51) Int. Cl. H04L 29/06

(52) U.S. Cl. CPC H04L 63/1458; H04L 63/1416; H04L 63/0236; H04L 63/20; H04L 63/166; H04L 63/1425

(57) ABSTRACT

A system and method for detecting and mitigating a Slow read DoS/DDoS attack on a server is described. Network packets from a client device in a real-time TCP connection are received and a TCP window size field (WSF) value is extracted from each packet. It is determined if the extracted WSF value is smaller than a preset WSF value. A first parameter is incremented when the WSF value of a packet is below the preset WSF value, and a second parameter is incremented when the WSF value for each successive packet is below the preset WSF value. A Slow read DoS/DDoS attack is detected when at least one of the first and the second parameters exceed the corresponding respective maximum limit. One or more actions are then carried out to mitigate the attack.

### TECHNICAL FIELD

The present invention relates generally to preventing Denial of Service/Distributed Denial of Service DOS/DDOS attack. More particularly, the present invention relates to detecting and mitigating a TCP Slow-Read denial-of-service/distributed denial of service (DoS/DDoS) attack based on TCP-ACK mechanism.

### BACKGROUND OF THE INVENTION

This section is intended to provide information relating to the field of the invention and thus any approach/functionality described below should not be assumed to be qualified as prior art merely by its inclusion in this section.

The growing importance of digital data storage has led to a proportional rise in the need for digital security. Software and machines are employed by attackers to exploit gaps in security measures and access the data of individuals, companies, ISPs providing web services. In recent years, there has been an increase in the number of attacks on web servers due to increased availability of attack engines (bots), and the capability to launch thousands of attacks against a web server to potentially bring down the server altogether.

The damage caused by DoS attacks causes services on the servers to become suspended and brings communication to a halt. Generally, DoS attacks are launched against websites, domain name servers etc., and deteriorate their availability. For instance, a DoS attack on a website accessed by millions of people, such as an e-commerce portal, can force it to temporarily cease operations, and may even cause destruction of files in the system.

The DoS attacks may be generally classified into two forms. The first form of DoS attack is that which crashes the server leading to its services becoming unavailable. The other form of DoS attack floods services of the server, using up the bandwidth and the processing capabilities of the server. Some of the common attack techniques include application layer attacks, degradation of service attacks, distributed DOS attacks (DDoS), HTTP slow POST DoS attack, Slow Read attack, SYN Flood attacks, teardrop attacks etc.

A DDOS is a variation of the DOS attack and occurs wherein large number of electronic devices work together to overwhelm a target electronic device with a flood of network traffic. DDOS attacks have increasingly become a threat to the services provided by internet service providers, large corporations, and governments around the world.

In a Slow READ DoS attack, the size of the client system's own reception buffer (to be notified to a server) is reduced such that the amount of information that the server can transmit at a time is reduced and the time required for communication is elongated to improperly occupy a server session. An HTTP Slow READ attack is executed using TCP's “window size” field. A TCP Receive window refers to a receive buffer for incoming data that has not yet been processed by the application. The size of the TCP Receive window is communicated to the server using the “window size” value field of the TCP header. The “window size” field is present in every TCP packet that is exchanged between the client and the server. It defines the number of bytes that the sender of a TCP packet (client system) is willing to receive at a given time or the quantum of data that can be sent before an acknowledgement is received. This is different from the TCP MSS option (an optional extension field in the TCP header), which indicates the maximum size of a single segment that the sender can receive. So while MSS can be, for example, 1460 bytes and will remain constant for the entire connection duration, the “window size” is a dynamically changing value, and can vary between 0 bytes to 1 Gigabytes.

A typical slow-read DoS/DDoS attack proceeds with a client system establishing a TCP connection to an Internet server. After the connection is established, the client system requests a valid service from the server, e.g. a HTTP GET request for retrieving some content, or any other protocol request. The server then processes the request, and is ready to start transmitting the response to the client system. The client system sends the receive “window size” with every packet—including in TCP SYN, subsequent request packet e.g. HTTP GET (or any other protocol that runs on top of TCP), and in the TCP ACK messages which acknowledges every TCP segment that the client system received from the server. If the response payload from the server is larger than the client system's “window size”, the server can send at most bytes of the “window size” to the client, before expecting a TCP ACK from the client system. The client system continuously acknowledges the data that the server sent by responding with a TCP ACK with a new “window size”. For causing an attack, a malicious client system carefully selects the request object, knowing that the response is large and, therefore, will exceed the client system's “window size”. The malicious client system performs one or more of the following actions as it receives the response from the server:
Sets the TCP receive window size to a small value, or even zero. The window size is set artificially to a small value, either initially at the time of connection initiation, or subsequently during the data transfer phase of the session where the client system responds to the incoming response data from the server with a TCP ACK with the new “window size”. TCP specification RFC 793 supports this mechanism, allowing the TCP server to accept a shrunk TCP window:
“The mechanisms provided allow a TCP to advertise a large window and to subsequently advertise a much smaller window without having accepted that much data. This, so called “shrinking the window,” is strongly discouraged. The robustness principle dictates that TCPs will not shrink the window themselves, but will be prepared for such behavior on the part of other TCPs.”
Never reads the response from the socket, which results in client system's own advertised “window size” gradually becoming zero.
Reads a few bytes at a time, and/or followed by sleeping for short durations. This results in the client's TCP socket receive buffer to start filling up, and the receive window size automatically reduces to a small value, or even zero.

When the server is ready to transmit the response to the client system, the server is aware of how much data the client system is willing to accept from the “window size” field of the client system's previous packet, whether that was a SYN, a request, or a TCP ACK packet. If the response is larger than the client's “window size”, the sender will send at most “window size” bytes before expecting a TCP ACK from the client system with the new window size of the client system. That data starts filling up the client system's socket receive buffer, and the client system sends a TCP ACK with a new receive “window size”. Due to the above actions, the receive “window size” of the client system keeps reducing, and the response to the server using the TCP ACK mechanism contains a small “window size”. The server receives the TCP ACK, and updates the transmit mechanism to send fewer and fewer bytes to this client system in subsequent transmission operations.

Thus, the server is able to keep sending fewer bytes till eventually the server is unable to send any data at all to the client system, or very small amounts of data at a time. Depending on the client system's receive “window size”, the server sends very few bytes at a time, and does not make much, if any, progress. This ties up resources on the server for long durations including File descriptors (socket and file descriptors), Memory (socket buffers for socket read/write), Connection table entries, CPU resources (managing thousands of attack connections, sending periodic acknowledgements to each client system to detect window size opening up, network utilization by I/O and bandwidth usage for potentially thousands of slow-read connections.

Various approaches have been made in to overcome the above problems. However, the conventional systems and methods are not without caveats and limitations. One such approach for managing said attacks includes killing the server process handling the particular client connection. A drawback of this approach is that as most servers today implement an event-based mechanism to handle client connections across multiple threads or processes, where each thread/process handles hundreds of connections, killing the server process would result in killing other valid connections.

Another known approach recognizes a malicious client device from previous requests that a client made and from the response received from the server to determine if the client request is a valid request or not. But such approach fails to handle the case where the client sends only one valid srequest and refuses to read the data, keeping the connection open for long times. Another known approach is to not accept initial connections (SYN packets) that have very small advertised window sizes. A limitation of this approach is the inability to anticipate attacks where the initial “window size” may be reasonable, but subsequently the “window size” may go down to a small number, or even zero, resulting in the stalling of the data transfer. Further, not allowing “window size” to reduce, breaks the TCP specification that allows “window size” to even become zero, and is the normal behavior across the Internet today.

Other known approach is to kill the connection if the client system's GET request has the same or smaller window size than the window size advertised in the SYN packet. However, such an approach is specific to HTTP and while the GET request may have the same window size, but the subsequent TCP ACKs that the client system sends in response may have smaller “window sizes”, thus, stalling the connection.

Yet another known mechanism involves not enabling persistent connection. However, this mechanism also does not work since even a single request may result in a slow-read attack. Yet another mechanism includes limiting total connection lifetime. However, this is unreasonable where the client system genuinely makes multiple valid requests, or a request serves large amounts of data, which is expected to take more time. Other known methods suggest setting tunable parameters for specific web server applications, but said methods also fail to solve the problem. For instance, setting the client_body_timeout as a resolution for specifically NGinx web servers is only meant to solve client systems sending requests at a slow pace, and not reading responses at a slow pace.

Thus, the existing mechanisms do not provide a universally successful way to anticipate, identify and eliminate the DOS/DDOS attacks in all types of situations. In view of the above, there arises a need to provide for alternative technical solutions that not only overcome the above disadvantages associated with the prior art but also provide for more efficient techniques to seamlessly identify and block DoS/DDoS attacks on server that are independent of any application or protocols and can work in-band as well as out-of-band.

### OBJECTS OF THE INVENTION

This section is intended to introduce certain objects of the disclosed methods and systems in a simplified form, and is not intended to identify the key advantages or features of the present disclosure.

An objective of the present invention is to provide improved techniques for detection and automatic mitigation of Slow-Read DoS/DDoS attacks that do not depend on any application or protocols (e.g. HTTP).

It is a further objective of the present invention to facilitate TCP Slow-Read DoS/DDoS attack identification and mitigation that is operable both in-band (at the server) as well as out-of-band (implemented at an intermediate device before the server).

Yet another object of the present invention is to provide a method for identifying and blocking DoS/DDoS attacks based on the TCP ACK mechanism irrespective of the initial window size.

Yet another object of the present invention is to handle a malicious client device that sends multiple bad requests, and also number of consecutive bad requests, for example, the client device either does not read the response, or reads the response very slowly after having made either a valid or invalid request.

Other general and specific objectives of the invention will in part be obvious and will in part appear hereinafter.

### BRIEF SUMMARY

According to one aspect of the present disclosure, a method for detecting and mitigating a Denial of Service/Distributed Denial of Service attack on a server is described. The method includes receiving, by a server, a plurality of network packets from a client device in a real-time TCP connection and parsing each of the plurality of network packets to extract a TCP window size field (WSF) value of the client device. The method then includes setting a first parameter and a second parameter for monitoring the WSF value for each of the plurality of packets and determining if the extracted WSF value is below a preset WSF value. The first parameter and the second parameter are then updated based on the determination including incrementing the first parameter when the WSF value of a packet is below the set WSF value, and incrementing the second parameter when the WSF value for each successive packet is below the set WSF value. Furthermore, the first parameter is then compared with a first threshold and the second parameter is compared with a second threshold. In response to the comparison, a denial of service attack is detected when at least one of the first and the second parameters exceed the first and second threshold respectively. Finally, the method includes performing one or more actions to mitigate the attack.

According to another aspect of the present disclosure, a system for detecting and mitigating a Denial of Service/Distributed Denial of Service attack on a server is described. The apparatus generally includes a receiving unit to receive a plurality of network packets from a client device in a real-time TCP connection, a connection socket to extract a TCP window size field (WSF) value of the client device for each of the plurality of network packets, and maintain a first parameter and a second parameter for monitoring the WSF value for each of the plurality of packets. The system further includes a detection engine configured to determine if the extracted WSF value is less than a set WSF value and update the first parameter and the second parameter based on the determination by incrementing the first parameter when the WSF value of a packet is below the set WSF value, and incrementing the second parameter when the WSF value for each successive packet is below the set WSF value. The detection engine is further configured to compare the first parameter with a first threshold and the second parameter with a second threshold and, detect a denial of service attack when at least one of the first and the second parameters exceed the first and second threshold respectively. Finally, the system includes an attack mitigation module/engine to perform one or more actions to mitigate the attack.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

FIGS. 1A and 1B illustrate exemplary network environments including a system for detecting and mitigating Denial of Service attack on a server, in accordance with an embodiment of the present invention.

FIG. 2 illustrates a block diagram of an example system for detecting and mitigating Denial of Service attack on a server, in accordance with an embodiment of the present invention.

FIG. 3 illustrates a flow diagram for an exemplary method of detecting and mitigating Denial of Service attack on a server that can be employed within the wireless communication system of FIGS. 1 and 2, in accordance with an embodiment of the present invention.

FIG. 4 illustrates another flow diagram for an exemplary method of detecting and mitigating Denial of Service attack on a server that can be employed within the system of FIGS. 1 and 2, in accordance with aspects of the present disclosure.

### DETAILED DESCRIPTION

The present disclosure relates to system and method for detection and mitigation of TCP Slow-Read DoS/DDoS attack(s) on server(s) using TCP-ACK mechanism. The system and method according to the subject matter disclosed herein will be explained in the context of flow diagrams, charts which can be implemented in hardware or a combination of hardware and software. In one embodiment, the hardware and software for attack detection and mitigation is located in a device operable to retrieve traffic from a network such as the Internet.

The subject matter disclosed herein discloses monitoring web activity to detect a potential attack by one or more client devices. The attack can be a slow-read denial of service or a distributed denial of service attack. A method and system according to an embodiment of the subject matter disclosed herein can implement one or more detection techniques for identifying a potential DoS/DDoS attack from one or more client device(s). A normal behaving user device may send a request, receive the response, and depending on the processing power of the user device, the receive window size may shrink to a lower value including even zero. However, as the user device reads the data sent by the server, the window size subsequently increases. Where, the window size of the client devices ceases to subsequently increase, such behavior is indicative of a TCP Slow Read DoS/DDoS attack on the server. On identifying a potential attack, the system takes measures to protect the server from the attack, thereby, preventing such attacks on the server harming the server performance.

The system, according to an embodiment, can monitor network traffic transmitted between the client device and the server for attack detection. The system can apply one or more engines to analyze the network packets received from the client device and extract a window size advertised by that client device. The extracted window size is then compared with a predetermined window size field value (“system-small-window-size”). When the extracted window size field value is below the predetermined window size field value, the system identifies such a request from the client device as having a “small window”. The system then updates at least one of a first parameter and a second parameter when the request from the client device includes a small window. The system further determines whether or not to generate an attack alert based upon the value of the first parameter and the second parameter exceeding a first threshold and a second threshold respectively.

More specifically, according to the embodiments of the present invention, when a new connection between the server and the client device is established, a count value for the total number of times the connection received packets with a “small window” and the number of times the connection received consecutive packets with a “small window” from the client system are set to zero. Every time a connection receives a packet from the client system with a “small window”, for example, as part of SYN request, or a TCP ACK that acknowledges the server's partially transmitted response, a count for the total number of times the connection received a small window size (first parameter) is incremented by one, and checked against a first threshold i.e. a maximum value of the total “small window” events beyond which a connection is deemed to be a bad connection. In the event, the total number of times the connection received a small window size exceeds said first threshold, the system performs one or more actions to prevent the DoS/DDoS attack. Where, the previous packet received from the client system also had a small TCP window size, a count for the number of times the connection received consecutive “small window” messages (second parameter) from the client system for this connection is incremented. Where a count for the number of times the connection received consecutive “small window” messages exceeds a second threshold i.e. a maximum value of consecutive “small window” events received, the connection is deemed to be bad/erratic.

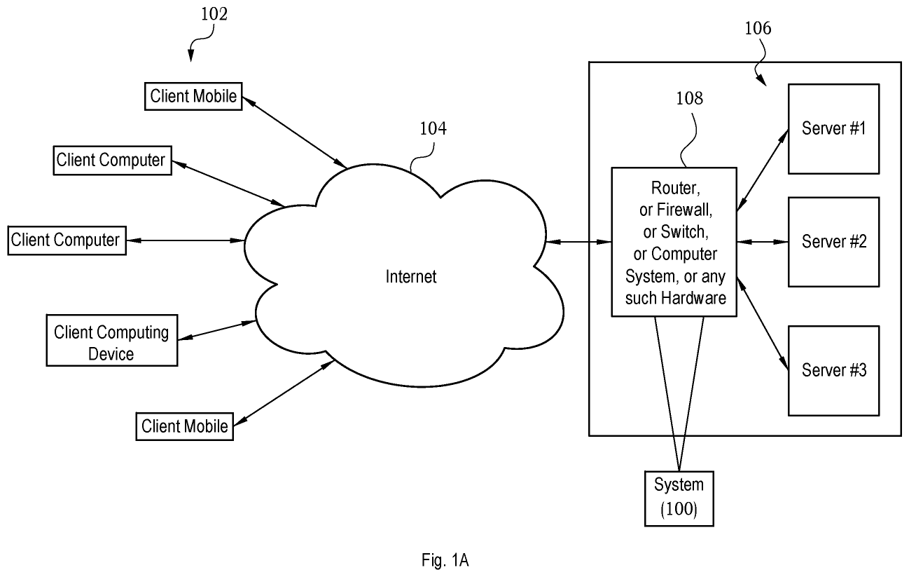

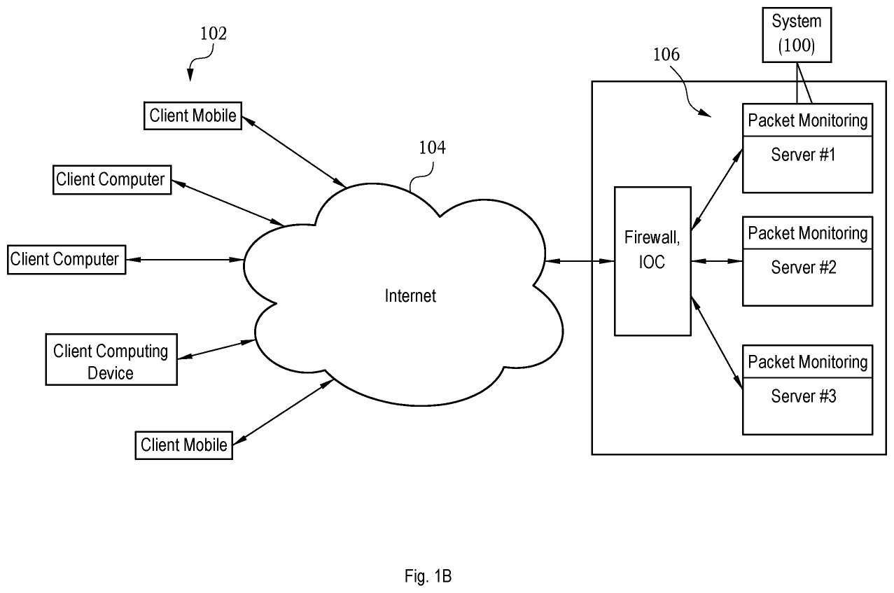

FIGS. 1A and 1B illustrate exemplary network environments including a system 100 for detecting and mitigating TCP Slow-Read DoS/DDoS attacks on a server. The network environment includes a plurality of client/user devices 102-1, 102-2 . . . 102-N, collectively referred to herein as 102. Examples of the client devices 102 may include, but are not limited to, a computing device, a mobile device, a portable computer, a personal digital assistant, a handheld device, a wearable computer, and any network-enabled devices capable of communicating with server 106 using standard Internet Protocols, such as HTTP, transmission control protocol (TCP), internet protocol (IP), etc. The client devices 102 access the one or more servers 106-1, 106-2 . . . 106-N, collectively referred to herein as 106 through a network 104 to request information from the server 106 and then receive results from the server 106. Client devices include computing devices controlled by a malware to cause an attack on the web server 106.

The server 106 can comprise any dedicated or shared server accessible by client devices 102. The server 106 service hypertext transfer protocol requests from client devices 102 for web pages hosted by the server 106. The server 106 is capable of being subjected to a DoS/DDoS by one or more malicious client device 102.

The network 104 may be a wireless network, a wired network, or a combination thereof. The network may be implemented as one of the different types of networks, such as an intranet, local area network (LAN), wide area network (WAN), the internet, etc. The network may either be a dedicated network or a shared network. The shared network may represent an association of the different types of networks that use a variety of protocols (e.g., Hypertext Transfer Protocol (HTTP), Transmission Control Protocol/Internet Protocol (TCP/IP), Wireless Application Protocol (WAP), etc.) used to connect computers and servers on the Internet. Further, the network may include a variety of network devices, including routers, bridges, servers, computing devices, storage devices, etc. Network 104 can include a network connection and the Internet for transmitting network traffic between the client devices 102 and the server 106. Data can be communicated between the client device 102 and the server 106 via HTTP over Transmission Control Protocol/Internet Protocol (TCP/IP), suite of communications protocols.

The system 100 for monitoring client requests and detecting a Slow Read Dos/DDoS attack is positioned between the client device 102 and the server 106 prone to the attack. As shown in FIG. 1A, the system 100 for detecting and mitigating the Slow-Read DoS/DDoS attack is present at an intermediate device 108 that intercepts and monitors traffic such as at a gateway device, at a router that forms the network, a firewall, a network switch or another computing device between the server 106 to be attacked and the network 104 (as shown inside blue lines). Further, as shown in FIG. 1B, the system 100 for detecting and mitigating the Slow-Read DoS/DDoS attack is present on the server 106 and is operable to retrieve traffic from the network. In one embodiment, the system 100 is integrated into the server TCP/IP networking stack. In another embodiment, the system 100 is implemented as a separate entity at the server 106.

Network traffic received by the system 100 consist of IP packets for various protocols. The system 100 receives the packets and recovers the window sizes advertised by client devices 102. The system 100 can associate received network traffic with a particular client device and a client session, such as an HTTP session.

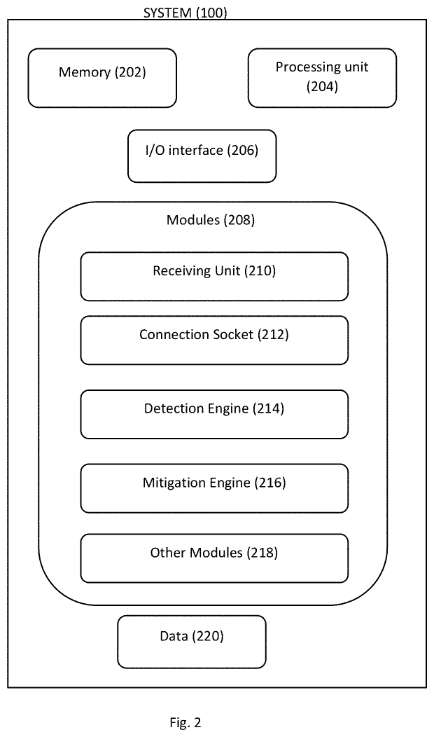

Referring to FIG. 2, an exemplary block diagram of a system 100 for detecting and mitigating a TCP Slow-Read DoS/DDoS attack on a server using TCP-ACK mechanism, is illustrated in accordance with an embodiment of the present disclosure. In one embodiment, the system 100 may include a memory 202, a processing unit 204, an input/output (I/O) interface 206, modules 208 and data 220.

The memory 202 may include a volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The processing unit 204 may be implemented as one or more microprocessors, microcomputers, microcontrollers, digital signal processors, central processing units, state machines, logic circuitries, and/or any devices that manipulate signals based on operational instructions. Among other capabilities, the processing unit 204 may be configured to fetch and execute computer-readable instructions stored in the memory 202.

The I/O interface 206 may include a variety of software and hardware interfaces, for example, a web interface, a graphical user interface, etc. The I/O interface 206 may allow the system 100 to interact with user(s) through the user devices 102. Further, the I/O interface 206 may enable the system 100 to communicate with other computing devices, such as web servers and external data servers (not shown). The I/O interface 206 can facilitate multiple communications within a wide variety of networks and protocol types, including wired networks (e.g. LAN, cable networks, etc.) and wireless networks (e.g., WLAN, cellular networks, or satellite networks). The I/O interface 206 may include one or more ports for connecting a number of devices to one another or to another server.

The modules 208 may include structural components, data structures, etc., encoders, decoders, etc. which perform particular tasks or functions. In one embodiment, the modules 208 may include a receiving unit 210, a connection socket 212, an attack detection engine 214, an attack mitigation engine 216, and other modules 218. The other modules 218 are configured to supplement applications and functions of the system 100.

The data 220, among other things, may serve as a repository for storing data processed, received, and generated by one or more of the modules 208. The data 220 may also include a system database, and other data generated from the operation of one or more modules in the other modules 218. Data 220 may also refer to Databases including one or more computing devices configured to store databases and transmit and/or receive information to and/or from client computing devices e.g., database management systems.

The system 100 comprises a receiving unit 210 operable to receive incoming and outgoing network packet stream once a session is established between the client device 102 and server 106. The receiving unit 210 includes a network interface to seamlessly receive and store network packets communicated to the server 106 by the client device 102. The network interface may include Ethernet network ports.

The system 100 further includes a connection socket 212 configured to maintain information relating to state of each connection for different established sessions between the server 106 and client device(s) 102 including a session ID and a client IP address. Said information may be obtained from the TCP/IP stack of the server 106. The connection socket 212 is configured to add one or more trackers to the per-connection data structure. The one or more trackers may be added as one of a part of the socket and other data structures associated with the connection. The one or more trackers added to the per-connection state include, but not limited to, the total number of small window events, the number of consecutive small window events, and frequency of small window events. A first parameter tracks a total number of times a connection receives a ‘small window’ packet from the client device 102. A second parameter indicates a number of times the connection receives consecutive ‘small window’ packets from the client device 102.

The connection socket 212 maintains a preset WSF value (“system-small-window-size”) for the connection such that any packet with an extracted WSF value below the preset WSF value is defined as a small window packet. In another embodiment, a small window event refers to a window with a size less than or equal to the preset WSF value. The preset WSF value is configured dynamically on the server system based on at least one of a type of the connection, available bandwidth and incoming and outgoing traffic stream in the connection. Alternatively, the preset WSF value (“system-small-window-size) is set by the system administrator. The “small window” size could be defined as zero, or a small number, e.g. 1, 50, 120 bytes, etc.

The connection socket 212 is further configured to set and maintain global system level parameters, which are subsequently used by the transport layer against the per-connection parameters (defined below), to determine which connections are potentially misbehaving. The global system level parameters/fields include a threshold value for a small window, a first threshold for a first parameter and a second threshold associated with a second parameter. The first threshold corresponds to the maximum value of the “small window” events beyond which a connection is deemed to be erratic and the second threshold corresponds to the maximum value of consecutive “small window” events received beyond which a connection is deemed to be erratic. This may be equal to, or smaller than the first threshold.

The connection socket 212 is configured to parse each network packet from the network connection to search for the TCP window size field (WSF) value advertised by the client device 102. The extracted WSF values are then processed by the attack detection engine 214.

The detection engine or detector 214 in the system in configured to use the information aggregated in each of connections to detect and alert of an attack on the server 106 by client device 102. The detection engine 214 is configured to process the information extracted from the packets directed to the server 106 and update a first parameter and a second parameter for each connection by monitoring the WSF value for each of the plurality of packets.

The detection engine 214 is configured to determine small window events associated with an incoming packet when the received network packet extracted WSF value is less than the predetermined WSF value (“system-small-window-size”). The first parameter and the second parameter are then updated based on the determination.

According to an embodiment, where a received packet is determined to have a small window, the first parameter (“total-small-windows-seen”) is incremented for each such packet. The detection engine 214 is configured to compare the value of a first parameter with the first threshold. Further when two consecutive packets having small windows are received, the second parameter (“consecutive-small-windows-seen”) is incremented for each consecutive small window packet. In other words, the attack detection engine 214 is configured to increment the second parameter for this connection if the previous packet received from this client also had a small TCP window size. The second parameter is then compared with the second threshold.

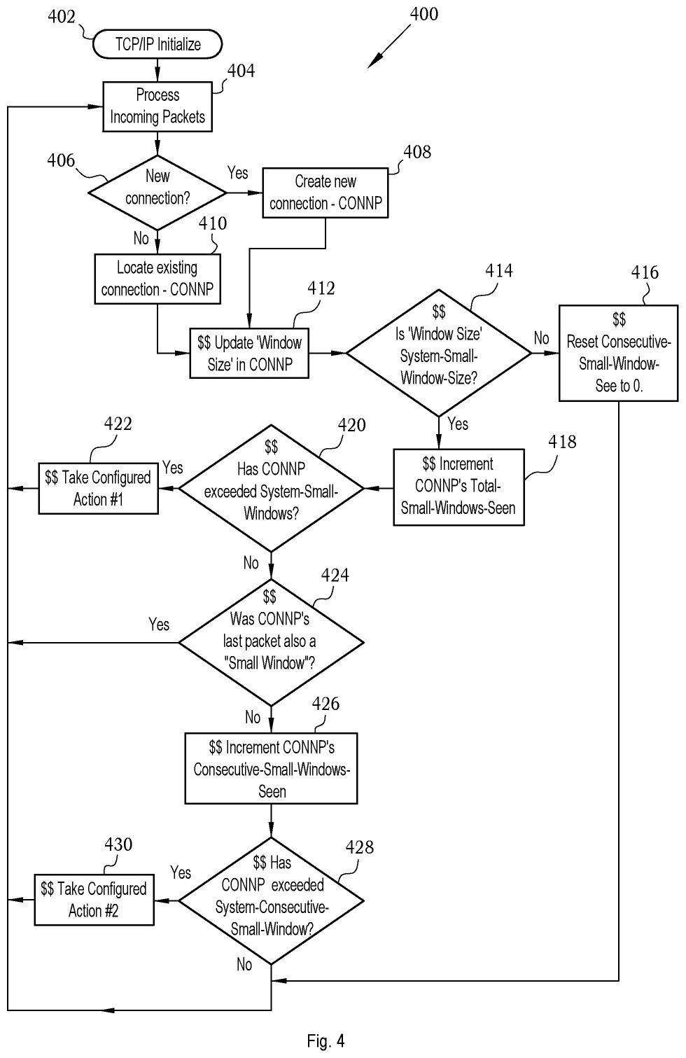

A DoS/DDoS attack is then detected when at least one of the first and the second parameters exceed the first and second threshold respectively. The detection engine 214 is then configured to trigger a DoS/DDoS attack notification to the mitigation engine 216. The detection engine 214 is configured to also associate the detected attack with particular user session(s), login session(s), IP address (es), a client device(s), and/or URL(s). In the event the server 106 receives several continuous small/zero window size events from a user device 102 in a series, the client device 102 is identified as misbehaving. The second parameter may typically be much lower than the first parameter for such a session. Exemplary embodiments and implementations of the detection engine 214 is described in further detail with reference to FIG. 4.

The attack mitigation engine 216 is configured to perform one or more specific actions to handle one or more different requirements in order to block or mitigate the detected DoS/DDoS attack. The one or more actions may be taken by the transport layer when a per-connection condition hits the system level thresholds. In one embodiment, the attack mitigation engine 216 is configured to perform same actions for attacks detected from total and consecutive ‘small window’ events. In another embodiment, the attack mitigation engine 216 is configured to perform separate and different actions for total and consecutive ‘small window’ events by expanding it to two separate fields for the two events. The one or more actions, include, but are not limited to: logging the errant connection including the client IP address, client port number, server connection details, number of ‘small window’ events received, etc., silently killing the connection, logging and killing the errant connection, setting a timeout for the connection to make progress before it is logged and killed, requiring a connection to progress at an acceptable bandwidth below which the connection is logged and killed and extend fields like frequency of ‘small window’ events etc.

The other modules 218 may include an output module such as a display interface for providing various screen displays for the detected attack.

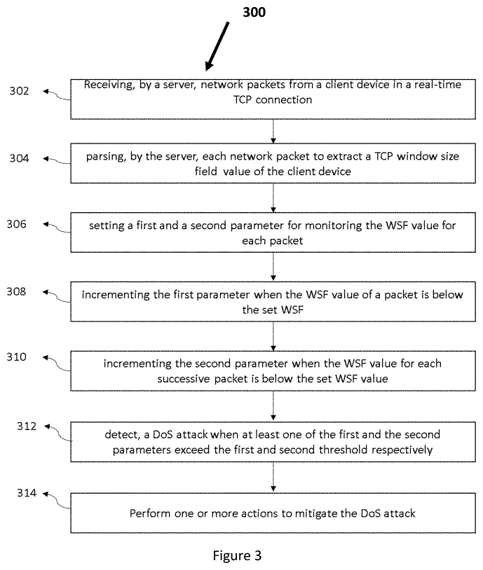

FIG. 3 illustrates a method 300 for detection and mitigation of a TCP Slow Read DoS/DDoS attack. Once a connection is established, the user device 102 and the server 106 communicate over the network packets as they communicate. The client devices 102 communicates the latest window size value in each packet. Each TCP header consists of the most recent window value, which grows or shrinks as the connection progresses.

At step 302, the server 106 receives network packets from the client device 102 in a real-time TCP connection. At step 304, the server 106 parses each request/network packet received from the client device to extract the most recent window size value advertised by the client device 102.

At step 306, the first and second parameter values are initialized to zero when the session is started. The first and second parameters monitor the WSF value for each of the plurality of packets and are updated when the WSF extracted from a received packet is less than a preset WSF value.

At step 308, the first parameter is incremented by on encountering a “small window” event and at step 310, a second parameter is incremented by one on encountering a consecutive “small window” event in the connection.

Further, at step 312, the first parameter is compared with a first threshold and a second parameter is compared with a second threshold. A DoS/DDoS attack is then detected when at least one of the first and the second parameters exceed the first and second threshold respectively. The type of the attack is also recognized. In an embodiment, the detected DoS/DDoS attack is a slow read DoD/DDoS attack.

Finally, one or more actions such as silently killing the connection, logging and killing the errant connection, setting a timeout for the connection to make progress before it is logged and killed, and requiring a connection to progress at an acceptable bandwidth below which the connection is logged and killed are performed so as to prevent the malicious client device 102 from attacking the server 106.

FIG. 4 is a high level flowchart depicting one or more operations performed in a process 400 for detecting and mitigating TCP Slow-Read DoS/DDoS attack on a server using TCP-ACK mechanism, in accordance with an embodiment of the present invention. The process 400 may be performed by the system 100. The process 400 initiates at block 402 with the initiation of the TCP/IP protocol, for instance, with the sending of the SYN packet by the client system 102 to the server 106. After the handshake, the user device 102 sends a HTTP GET request to the server. Every time a connection receives a packet from the client system 102 (whether as part of SYN, a client request, or a client's TCP ACK message that acknowledges the server's partially transmitted response), the system 100 examines the incoming packets at block 404.

In block 406, it is checked if a new connection is requested. When a new connection is requested, a new data structure e.g. CONNP is created in block 408. The first parameter (“total-small-windows-seen”) and the second parameter (“consecutive-small-windows-seen”) fields for the connection CON NP are set to zero. Otherwise, if the incoming packets are associated with an existing connection, the data structure CONNP associated with the existing connection is located and updated in block 410.

In block 412, a window size advertised by the client device 102 is extracted from the TCP header of the incoming packets and updated in the data structure CONNP. The extracted window size is then compared with a preset WSF size specified in the “system-small-window-size” field in block 414. If the extracted window size is equal or greater than the preset small window size field value, the second parameter is reset to 0/default in block 416. Conversely, where the window size is determined to be smaller than the preset WSF value, the first parameter is incremented by one at block 418.

In block 420, the first parameter value for the connection CONNP is compared with the first threshold i.e. maximum value of the total number of the ‘small window’ events. If the value in the data structure CON NP is determined to exceed the first threshold, said connection is identified as erratic. In block 422, one or more specific actions are then performed to block the connection.

On the other hand, when the first parameter value in the data structure CONNP is determined to be same or smaller than the first threshold, in block 424, it is further determined whether the previous packet from the user device in said connection also had a window size smaller than the preset WSF value and accordingly, the second parameter for the connection CONNP is incremented by one in block 426. Furthermore, in block 428, the process compares the second parameter for the connection ‘CONNP’ with the second threshold i.e. maximum value of events of consecutive ‘small window’. Where second parameter is determined to exceed the second threshold, the connection is identified as erratic and one or more actions to block the connection are performed in block 430 as in block 422.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

An exemplary situation of a packet flow where the attack is initiated is illustrated in Table 1 below:

TABLE 1

| No | Time | Source | Destination | TCPLen | Seq # | Info |
|---|---|---|---|---|---|---|
| 1 | 0 | 192.168.29.238 | 23.236.xx.yyy | 0 | 0 | 60922→80 [SYN] Seq = 0 Win = 64240 Len = 0 |
| | | | | | | 80→60922 [SYN ACK] Seq = 0 Ack = 1 |
| 2 | 0.315981 | 23.236.xx.yyy | 192.168.29.238 | 0 | 0 | Win = 28160 Len = 0 |
| | | | | | | 60922→80 [ACK] Seq = 1 Ack = 1 Win = 64256 |
| 3 | 0.316098 | 192.168.29.238 | 23.236.xx.yyy | 0 | 1 | Len = 0 |
| 4 | 0.316226 | 192.168.29.238 | 23.236.xx.yyy | 32 | 1 | GET/HTTP/1.1 |
| | | | | | | 80→60922 [ACK] Seq = 1 Ack = 33 Win = 28160 |
| 5 | 0.555506 | 23.236.xx.yyy | 192.168.29.238 | 1408 | 1 | Len = 1408 |
| | | | | | | 60922→80 [ACK] Seq = 33 Ack = 1409 |
| 6 | 0.55555 | 192.168.29.238 | 23.236.xx.yyy | 0 | 33 | Win = 63104 Len = 0 |
| | | | | | | 80→60922 [ACK] Seq = 1409 Ack = 33 |
| 7 | 0.56483 | 23.236.xx.yyy | 192.168.29.238 | 12672 | 1409 | Win = 28160 Len = 12672 |
| | | | | | | 60922→80 [ACK] Seq = 33 Ack = 14081 |
| 8 | 0.564878 | 192.168.29.23 | 8 23.236.xx.yyy | 0 | 33 | Win = 50432 Len = 0 |
| | | | | | | 80→60922 [ACK] Seq = 14081 Ack = 33 |
| 9 | 0.931163 | 23.236.xx.yyy | 192.168.29.238 | 1408 | 14081 | Win = 28160 Len = 1408 |
| | | | | | | 60922→80 [ACK] Seq = 33 Ack = 15489 |
| 10 | 0.93123 | 192.168.29.238 | 23.236.xx.yyy | 0 | 33 | Win = 49024 Len = 0 |
| | | | | | | 80→60922 [ACK] Seq = 15489 Ack = 33 |
| 11 | 0.931517 | 23.236.xx.yyy | 192.168.29.238 | 1408 | 15489 | Win = 28160 Len = 1408 |
| | | | | | | 60922→80 [ACK] Seq = 33 Ack = 16897 |
| 12 | 0.931559 | 192.168.29.238 | 23.236.xx.yyy | 0 | 33 | Win = 47616 Len = 0 |
| | | | | | | 80→60922 [ACK] Seq = 16897 Ack = 33 |
| 13 | 0.932181 | 23.236.xx.yyy | 192.168.29.238 | 1408 | 16897 | Win = 28160 Len = 1408 |
| | | | | | | 60922→80 [ACK] Seq = 33 Ack = 18305 |
| 14 | 0.932236 | 192.168.29.238 | 23.236.xx.yyy | 0 | 33 | Win = 46208 Len = 0 |
| | | | | | | 80→60922 [ACK] Seq = 18305 Ack = 33 |
| 15 | 0.933325 | 23.236.xx.yyy | 192.168.29.238 | 11264 | 18305 | Win = 28160 Len = 11264 |
| | | | | | | 80→60922 [ACK] Seq = 29569 Ack = 33 |
| 16 | 0.935001 | 23.236.xx.yyy | 192.168.29.238 | 12672 | 29569 | Win = 28160 Len = 12672 |
| | | | | | | 60922→80 [ACK] Seq = 33 Ack = 42241 |
| 17 | 0.974893 | 192.168.29.238 | 23.236.xx.yyy | 0 | 33 | Win = 22272 Len = 0 |
| | | | | | | 80→60922 [ACK] Seq = 42241 Ack = 33 |
| 18 | 1.545143 | 23.236.xx.yyy | 192.168.29.238 | 1408 | 42241 | Win = 28160 Len = 1408 |
| | | | | | | 80→60922 [ACK] Seq = 43649 Ack = 33 |
| 19 | 1.545534 | 23.236.xx.yyy | 192.168.29.238 | 1408 | 43649 | Win = 28160 Len = 1408 |
| | | | | | | 80→60922 [ACK] Seq = 45057 Ack = 33 |
| 20 | 1.545857 | 23.236.xx.yyy | 192.168.29.238 | 1408 | 45057 | Win = 28160 Len = 1408 |
| | | | | | | 80→60922 [ACK] Seq = 46465 Ack = 33 |
| 21 | 1.546413 | 23.236.xx.yyy | 192.168.29.238 | 4224 | 46465 | Win = 28160 Len = 4224 |
| | | | | | | 80→60922 [ACK] Seq = 50689 Ack = 33 |
| 22 | 1.54792 | 23.236.xx.yyy | 192.168.29.238 | 8448 | 50689 | Win = 28160 Len = 8448 |
| | | | | | | 80→60922 [ACK] Seq = 59137 Ack = 33 |
| 23 | 1.547957 | 23.236.xx.yyy | 192.168.29.238 | 5376 | 59137 | Win = 28160 Len = 5376 |
| | | | | | | 60922→80 [ACK] Seq = 33 Ack = 64513 Win = 0 |
| 24 | 1.556567 | 192.168.29.238 | 23.236.xx.yyy | 0 | 33 | Len = 0 |
| | | | | | | 80→60922 [ACK] Seq = 64512 Ack = 33 |
| 25 | 2.774984 | 23.236.xx.yyy | 192.168.29.238 | 0 | 64512 | Win = 28160 Len = 0 |
| | | | | | | 60922→80 [ACK] Seq = 33 Ack = 64513 Win = 0 |
| 26 | 2.775039 | 192.168.29.238 | 23.236.xx.yyy | 0 | 33 | Len = 0 |
| | | | | | | 80→60922 [ACK] Seq = 64512 Ack = 33 |
| 27 | 4.911349 | 23.236.xx.yyy | 192.168.29.238 | 0 | 64512 | Win = 28160 Len = 0 |
| | | | | | | 60922→80 [ACK] Seq = 33 Ack = 64513 Win = 0 |
| 28 | 4.911407 | 192.168.29.238 | 23.236.xx.yyy | 0 | 33 | Len = 0 |
| | | | | | | 80→60922 [ACK] Seq = 64512 Ack = 33 |
| 29 | 9.122597 | 23.236.xx.yyy | 192.168.29.238 | 0 | 64512 | Win = 28160 Len = 0 |
| | | | | | | 6092280 [ACK] Seq = 33 Ack = 64513 Win = 0 |
| 30 | 9.122653 | 192.168.29.238 | 23.236.xx.yyy | 0 | 33 | Len = 0 |
| | | | | | | 80→60922 [ACK] Seq = 64512 Ack = 33 |
| 31 | 16.906898 | 23.236.xx.yyy | 192.168.29.238 | 0 | 64512 | Win = 28160 Len = 0 |
| | | | | | | 60922→80 [ACK] Seq = 33 Ack = 64513 Win = 0 |
| 32 | 16.906964 | 192.168.29.238 | 23.236.xx.yyy | 0 | 33 | Len = 0 |
| | | | | | | 80→60922 [ACK] Seq = 64512 Ack = 33 |
| 33 | 32.265668 | 23.236.xx.yyy | 192.168.29.238 | 0 | 64512 | Win = 28160 Len = 0 |
| | | | | | | 6092280 [ACK] Seq = 33 Ack = 64513 Win = 0 |
| 34 | 32.265738 | 192.168.29.238 | 23.236.xx.yyy | 0 | 33 | Len = 0 |
| | | | | | | 80→60922 [ACK] Seq = 64512 Ack = 33 |
| 35 | 62.985893 | 23.236.xx.yyy | 192.168.29.238 | 0 | 64512 | Win = 28160 Len = 0 |
| | | | | | | 6092280 [ACK] Seq = 33 Ack = 64513 Win = 0 |
| 36 | 62.98595 | 192.168.29.238 | 23.236.xx.yyy | 0 | 33 | Len = 0 |
| | | | | | | 6092280 [ACK] Seq = 33 Ack = 64513 |
| 37 | 92.12767 | 192.168.29.238 | 23.236.xx.yyy | 0 | 33 | Win = 18816 Len = 0 |
| | | | | | | 80→60922 [ACK] Seq = 64513 Ack = 33 |
| 38 | 93.502202 | 23.236.xx.yyy | 192.168.29.238 | 1408 | 64513 | Win = 28160 Len = 1408 |
| | | | | | | 6092280 [ACK] Seq = 33 Ack = 65921 |
| 39 | 93.502288 | 192.168.29.238 | 23.236.xx.yyy | 0 | 33 | Win = 17408 Len = 0 |
| | | | | | | 80→60922 [ACK] Seq = 65921 Ack = 33 |
| 40 | 93.736564 | 23.236.xx.yyy | 192.168.29.238 | 1488 | 65921 | Win = 28160 Len = 1488 |
| | | | | | | 80→60922 [ACK] Seq = 67409 Ack = 33 |
| 41 | 93.73657 | 23.236.xx.yyy | 192.168.29.238 | 12672 | 67409 | Win = 28160 Len = 12672 |
| | | | | | | 80→60922 [ACK] Seq = 80081 Ack = 33 |
| 42 | 93.748992 | 23.236.xx.yyy | 192.168.29.238 | 1584 | 80081 | Win = 28160 Len = 1584 |
| | | | | | | 80→60922 [ACK] Seq = 81665 Ack = 33 |
| 43 | 93.748995 | 23.236.xx.yyy | 192.168.29.238 | 1664 | 81665 | Win = 28160 Len = 1664 |
| | | | | | | 60922→80 [ACK] Seq = 33 Ack = 83329 Win = 0 |
| 44 | 93.778522 | 192.168.29.238 | 23.236.xx.yyy | 0 | 33 | Len = 0 |
| | | | | | | 80→60922 [ACK] Seq = 83328 Ack = 33 |
| 45 | 94.935037 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 46 | 94.935094 | 192.168.29.238 | 23.236.xx.yyy | 0 | 33 | Len = 0 |
| | | | | | | 80→60922 [ACK] Seq = 83328 Ack = 33 |
| 47 | 96.984411 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 48 | 96.984484 | 192.168.29.238 | 23.236.xx.yyy | 0 | 33 | Len = 0 |
| | | | | | | 80→60922 [ACK] Seq = 83328 Ack = 33 |
| 49 | 100.66992 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 50 | 100.669976 | 192.168.29.238 | 23.236.xx.yyy | 0 | 33 | Len = 0 |
| | | | | | | 80→60922 [ACK] Seq = 83328 Ack = 33 |
| 51 | 108.042467 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 52 | 108.042528 | 192.168.29.238 | 23.236.xx.yyy | 0 | 33 | Len = 0 |
| | | | | | | 80→60922 [ACK] Seq = 83328 Ack = 33 |
| 53 | 122.378851 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 54 | 122.378909 | 192.168.29.238 | 23.236.xx.yyy | 0 | 33 | Len = 0 |
| | | | | | | 80→60922 [ACK] Seq = 83328 Ack = 33 |
| 55 | 150.037004 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 56 | 150.037064 | 192.168.29.238 | 23.236.xx.yyy | 0 | 33 | Len = 0 |
| | | | | | | 80→60922 [ACK] Seq = 83328 Ack = 33 |
| 57 | 206.833574 | 23.236.xx.yyy | 192.168.29.238 | 0 | 83328 | Win = 28160 Len = 0 |
| | | | | | | 6092280 [ACK] Seq = 33 Ack = 83329 Win = 0 |
| 58 | 206.833634 | 192.168.29.238 | 23.236.xx.yyy | 0 | 33 | Len = 0 |
| | | | | | | 6092280 [ACK] Seq = 33 Ack = 83329 |
| 59 | 211.721314 | 192.168.29.238 | 23.236.xx.yyy | 0 | 33 | Win = 27008 Len = 0 |
| | | | | | | 80→60922 [ACK] Seq = 83329 Ack = 33 |
| 60 | 211.956327 | 23.236.xx.yyy | 192.168.29.238 | 2816 | 83329 | Win = 28160 Len = 2816 |
| | | | | | | 80→60922 [ACK] Seq = 86145 Ack = 33 |
| 61 | 211.958483 | 23.236.xx.yyy | 192.168.29.238 | 22528 | 86145 | Win = 28160 Len = 22528 |
| | | | | | | 80→60922 [ACK] Seq = 108673 Ack = 33 |
| 62 | 211.958601 | 23.236.xx.yyy | 192.168.29.238 | 1664 | 108673 | Win = 28160 Len = 1664 |
| | | | | | | 6092280 [ACK] Seq = 33 Ack = 110337 Win = 0 |
| 63 | 212.010941 | 192.168.29.238 | 23.236.xx.yyy | 0 | 33 | Len = 0 |
| | | | | | | 80→60922 [ACK] Seq = 194305 Ack = 33 |
| 121 | 544.295442 | 23.236.xx.yyy | 192.168.29.238 | 8448 | 194305 | Win = 28160 Len = 8448 |
| | | | | | | 6092280 [ACK] Seq = 33 Ack = 202753 |
| 122 | 544.346956 | 192.168.29.238 | 23.236.xx.yyy | 0 | 33 | Win = 512 Len = 0 |
| | | | | | | 80→60922 [ACK] Seq = 202753 Ack = 33 |
| 123 | 545.516623 | 23.236.xx.yyy | 192.168.29.238 | 512 | 202753 | Win = 28160 Len = 512 |
| | | | | | | 6092280 [ACK] Seq = 33 Ack = 203265 Win = 0 |
| 124 | 545.516688 | 192.168.29.238 | 23.236.xx.yyy | 0 | 33 | Len = 0 |
| | | | | | | 80→60922 [ACK] Seq = 203264 Ack = 33 |
| 125 | 546.556908 | 23.236.xx.yyy | 192.168.29.238 | 0 | 203264 | Win = 28160 Len = 0 |
| | | | | | | 60→92280 [ACK] Seq = 33 Ack = 203265 Win = 0 |
| 126 | 546.55694 | 192.168.29.238 | 23.236.xx.yyy | 0 | 33 | Len = 0 |
| | | | | | | 80→60922 [ACK] Seq = 203264 Ack = 33 |
| 127 | 548.317425 | 23.236.xx.yyy | 192.168.29.238 | 0 | 203264 | Win = 28160 Len = 0 |
| | | | | | | 6092280 [ACK] Seq = 33 Ack = 203265 Win = 0 |
| 128 | 548.317482 | 192.168.29.238 | 23.236.xx.yyy | 0 | 33 | Len = 0 |
| | | | | | | 80→60922 [ACK] Seq = 203264 Ack = 33 |
| 129 | 551.454585 | 23.236.xx.yyy | 192.168.29.238 | 0 | 203264 | Win = 28160 Len = 0 |
| | | | | | | 6092280 [ACK] Seq = 33 Ack = 203265 Win = 0 |
| 130 | 551.454641 | 192.168.29.238 | 23.236.xx.yyy | 0 | 33 | Len = 0 |
| | | | | | | 80→60922 [ACK] Seq = 203264 Ack = 33 |
| 131 | 557.598423 | 23.236.xx.yyy | 192.168.29.238 | 0 | 203264 | Win = 28160 Len = 0 |
| | | | | | | 6092280 [ACK] Seq = 33 Ack = 203265 Win = 0 |
| 132 | 557.598479 | 192.168.29.238 | 23.236.xx.yyy | 0 | 33 | Len = 0 |
| | | | | | | 80→60922 [ACK] Seq = 203264 Ack = 33 |
| 133 | 592.00711 | 23.236.xx.yyy | 192.168.29.238 | 0 | 203264 | Win = 28160 Len = 0 |
| | | | | | | 6092280 [ACK] Seq = 33 Ack = 203265 Win = 0 |
| 134 | 592.007142 | 192.168.29.238 | 23.236.xx.yyy | 0 | 33 | Len = 0 |
| | | | | | | 80→60922 [ACK] Seq = 203264 Ack = 33 |
| 135 | 637.38233 | 23.236.xx.yyy | 192.168.29.238 | 0 | 203264 | Win = 28160 Len = 0 |
| | | | | | | 6092280 [ACK] Seq = 33 Ack = 203265 Win = 0 |
| 136 | 637.382388 | 192.168.29.238 | 23.236.xx.yyy | 0 | 33 | Len = 0 |
| | | | | | | 6092280 [ACK] Seq = 33 Ack = 203265 |
| 137 | 704.712188 | 192.168.29.238 | 23.236.xx.yyy | 0 | 33 | Win = 48256 Len = 0 |
| | | | | | | 80→60922 [ACK] Seq = 203265 Ack = 33 |
| 138 | 705.062767 | 23.236.xx.yyy | 192.168.29.238 | 2304 | 203265 | Win = 28160 Len = 2304 |
| | | | | | | 6092280 [ACK] Seq = 33 Ack = 205569 |
| 139 | 705.062797 | 192.168.29.238 | 23.236.xx.yyy | 0 | 33 | Win = 45952 Len = 0 |
| | | | | | | 80→60922 [ACK] Seq = 205569 Ack = 33 |
| 140 | 705.065734 | 23.236.xx.yyy | 192.168.29.238 | 28160 | 205569 | Win = 28160 Len = 28160 |
| | | | | | | 80→60922 [ACK] Seq = 233729 Ack = 33 |
| 141 | 705.065734 | 23.236.xx.yyy | 192.168.29.238 | 1408 | 233729 | Win = 28160 Len = 1408 |
| | | | | | | 60922→80 [FIN ACK] Seq = 33 Ack = 236546 |
| 245 | 1184.594707 | 192.168.29.238 | 23.236.xx.yyy | 0 | 33 | Win = 64128 Len = 0 |
| | | | | | | 80→60922 [FIN ACK] Seq = 236546 Ack = 34 |
| 246 | 1185.231106 | 23.236.xx.yyy | 192.168.29.238 | 0 | 33 | Win = 28120 Len = 0 |

The packet flow as seen above in Table 1 is explained as below:

1. Packets #1-3: The user/client system 102 and the Server 106 establish a connection. The initial client system 102 window size is 64240.

2. Packet #4: The client system 102 makes a HTTP request.

3. Packets #5-23: The Server 106 sends response data in multiple packets to the client system 102, the client system 102 acknowledges data at irregular intervals by sending TCP ACK's with shrinking TCP window size.

4. Packet #24: The Client system 102 ACK is a total of 64513 bytes of data and advertises a ZERO window. The ZERO window indicates that the TCP receive buffer is full and cannot receive any more data.

5. Packet #25: The Server 106 attempts to find if the client system's window has opened up or not with a zero byte TCP packet.

6. Packet #26: The Client system 102 responds with a zero byte Window.

7. Packet #27-36: This sequence of the server 106 checking for the client system 102's window opening up, and the client system 102 responding with a ZERO window continues.

8. Packet #37: The Client system 102 opens the window to the server 106, with a value of 18816.

9. Packet #38-43: Communication resumes.

10. Packet #44-59: Communication stops due to zero window.

11. Packet #60-63: Communication resumes.

12. And so on.

13. Packet #121: The Server system 106 sends 8448 bytes.

14. Packet #122: The Client system 102 sends a TCP ACK, with window of 512 bytes.

15. Packet #123: The server system 106 sends just 512 bytes as requested by client.

16. Packet #124-137: Communication stops.

17. Packet #138-141: Communication continues 18. And so on.

19. Finally, at 1185 seconds, the entire transfer of 236546 bytes is finished.

20. Transfer took close to 20 minutes, and average transfer rate of this connection was just 199 bytes/second.

As illustrated in Table 1, the operation of the server 106 is impacted as the server kept this connection open for almost 20 minutes to serve a small amount of data to one client system 102. During this time, the server 106 uses up memory, CPU, sockets, file-descriptors, etc. to maintain this connection. In case of multiple sessions similarly established, from the same or many client devices, the server may easily run out of resources.

The present invention encompasses solutions to identify and block such an attack on the server by identifying the total small window events and consecutive small window events based on the TCP acknowledgement in the manner described in the invention.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the structuring and implementation within the principles of the invention to the full extent indicated by the broad general meaning of the terms. Thus various modifications are possible of the presently disclosed system and method without deviating from the intended scope and spirit of the present invention.

We claim:

1. A method for detecting and mitigating a Denial of Service attack on a server, the method comprising:
receiving, by a server, a plurality of network packets from a client device in a real-time TCP connection;
parsing, by the server, each of the plurality of network packets to extract a TCP window size field (WSF) value of the client device;
setting a first parameter and a second parameter for monitoring the WSF value for each of the plurality of packets;
determining, by the server, if the extracted WSF value is below a set WSF value;
updating the first parameter and the second parameter based on the determination including
incrementing the first parameter when the WSF value of a packet is below the set WSF value, and
incrementing the second parameter when the WSF value for each successive packet is below the set WSF value,
comparing the first parameter with a first threshold and the second parameter with a second threshold;
in response to comparison, detecting, by the server, a denial of service attack when at least one of the first and the second parameters exceed the first and second threshold respectively;
performing one or more actions to mitigate the attack.

2. The method as claimed in claim 1, wherein the first parameter corresponds to a total number of times the connection received packets having the WSF value below the set WSF value and the second parameter corresponds to a number of times the connection received successive packets having the WSF below the set WSF value.

3. The method as claimed in claim 1, wherein the set WSF value, first threshold and second threshold is set dynamically based on at least one of a type of the connection, available bandwidth and traffic stream in the connection.

4. The method as claimed in claim 1, comprising updating the second parameter includes reset-ting the second parameter for the packet having the WSF value same or exceeding the set WSF value.

5. The method as claimed in claim 1, wherein the one or more actions include, but not limited to, logging the connection, killing the connection and setting a timeout or a minimum acceptable bandwidth for the connection to progress.

6. The method as claimed in claim 1, comprising detecting the denial of service attack based on a third parameter corresponding to a frequency of receiving the network packets.

7. A system for detecting and mitigating a Denial of Service attack on a server, the system comprising:
a receiving unit (210) to receive a plurality of network packets from a client device (102) in a real-time TCP connection;
a connection socket (212) to
extract a TCP window size field (WSF) value of the client device for each of the plurality of network packets, and
maintain a first parameter and a second parameter for monitoring the WSF value for each of the plurality of packets;
a detection engine (214) to
determine if the extracted WSF value is less than a set WSF value,
update the first parameter and the second parameter based on the determination including incrementing the first parameter when the WSF value of a packet is below the set WSF value, and incrementing the second parameter when the WSF value for each successive packet is below the set WSF value,
compare the first parameter with a first threshold and the second parameter with a second threshold; and
in response to comparison, detect, a denial of service attack when at least one of the first and the second parameters exceed the first and second threshold respectively;
an attack mitigation engine (216) to perform one or more actions to mitigate the detected attack.

8. The system as claimed in claim 7, wherein the connection socket (212) is configured to dynamically set the WSF value, the first threshold value and the second threshold value based on at least one of a type of the connection, available bandwidth and traffic stream in the connection.

9. The system as claimed in claim 7, wherein the first parameter corresponds to a total number of times the connection received packets having the WSF value below the set WSF value and the second parameter corresponds to a number of times the connection received successive packets having the WSF below the set WSF value.

10. The system as claimed in claim 7, comprising the attack detection engine (214) configured to reset the second parameter for the packet having the WSF value same or exceeding the set WSF value.

11. The system as claimed in claim 7, wherein the attack mitigation engine (216) is configured to perform one or more actions including, but not limited to, logging the connection, killing the connection and setting a timeout or a minimum acceptable bandwidth for the connection to progress.

12. The system as claimed in claim 7, comprising the attack detection engine (214) is configured to detect the denial of service attack based on a third parameter corresponding to a frequency of receiving the network packets.
